(19) United States
(12) Patent Application Publication
(10) Pub. No.: US 2024/0337540 A1
(43) Pub. Date: Oct. 10, 2024

(54) SYSTEM AND METHOD FOR SOLVING THE STEADY-STATE TEMPERATURE PROFILE IN A THERMAL ENVIRONMENT EXHIBITING ALGEBRAIC NONLINEARITIES

(71) Applicant: Aplicaciones en Informática Avanzada, S.L., Sant Cugat del Vallès (ES)

(72) Inventor: Antonio Trias, Sant Cugat del Valles (ES)

(73) Assignee: Aplicaciones en Informática Avanzada, S.L., Sant Cugat del Vallès (ES)

(21) Appl. No.: 18/192,220

(22) Filed: Mar. 29, 2023

(51) Int. Cl. G01K 3/06

(52) U.S. Cl. CPC G01K 3/06

(57) ABSTRACT

Different aspects of the invention comprise an innovative apparatus, method, and system, for determining the steady-state temperatures of nodes in a thermal environment comprising non-linearities. The determination is performed directly, non-iteratively, and guarantees the optimum solution: the end result is an unequivocal answer: it yields the operational solution if it exists, and conversely, it signals unfeasibility when it does not exist.

### TECHNICAL FIELD

The present invention relates generally to the field of heat flow studies, also known as flow studies of thermal systems, and, in particular, to the determination of the steady-state operating point of thermal environments.

### BACKGROUND OF THE INVENTION

A thermal environment is any environment comprising thermal nodes having known and/or unknown temperatures connected via heat transfer carriers. Some nodes have a positive thermal impact (heat sources generating heat), such as an electric heater or a motor. Other nodes have a negative thermal impact (heat sinks having a cooling effect), such as a cooling circuit or an air conditioning unit. In an environment comprising a plurality of nodes, typically heat transfer occurs between nodes via heat carriers, such as air, liquids, rooms, walls, containers, or housing. Hence, any thermal environment can be modeled as a combination of heat sources, sinks, and carriers.

In any such environment, it is desirable to solve for its steady-state operating point, in order to efficiently manage it, be it a large factory, a building, a small vehicle, or even an integrated circuit. The solution can then be used for system design applications, as well as in all sorts of high-level algorithmic control.

Prior art algorithms for solving for the temperatures at the nodes of a thermal environment exist. However, they all have one thing in common, which is their reliance on numerical iteration as the root-finding technique lying at the core of the procedure. Examples of these core techniques are Gauss-Seidel iteration and the Newton-Raphson method. However, such prior art solutions cannot guarantee convergence, requiring operator intervention to assure the solution makes sense. This poses a serious problem of reliability, as the underlying iterative algorithms could fail to converge in such a manner that it is not possible to know, or discover, why.

Therefore, a need exists to effectively solve the abovementioned problems.

### SUMMARY

It is therefore an object of the present invention to provide solutions to the above-mentioned problems. In particular, it is an object of the invention to provide an algorithm that is the adaptation of the Holomorphic Embedding Load Flow Method, HELM, first described in U.S. Pat. Nos. 7,519,506 and 7,979,239 to A. Trias, for efficiently solving for the steady-state operating point of thermal environments and successfully determining a definitive temperature at each node. For the rest of this disclosure, this enhancement will be referred to as Thermal-HELM (T-HELM short annotation).

Thermal environments comprise nonlinearities that must be represented in the corresponding heat flow equations, which raises serious challenges for traditional nonlinear analysis based on Newton-Raphson and similar iterative numerical methods. The system has, in general, a huge number of different solutions, of the order of 2^{N}, where N is the number of nodes in the thermal environment. A numerical iterative method may either diverge or converge onto any of these, depending on the chosen initial seed, with no predictability.

The innovation disclosed here addresses this problem, among others. In order to apply the general theory of HELM, a heat flow equation is embedded using a complex parameter s, together with the appropriate boundary conditions for said parameter, so that the reduction to an algebraic curve is guaranteed. Once this is achieved, the mathematical theory of HELM applies, provided suitable non-evident modifications are performed for adaptation to thermal environments. Then, by applying the HELM-based power series technique, the germ of the operational solution is constructively computed. The end result is an unequivocal answer: it yields the operational solution if it exists, and conversely, it signals unfeasibility when it does not exist.

Additionally, the disclosed algorithm is also shown to contemplate the higher-order nonlinearities that are characteristic of devices commonly encountered in spacecraft, aircraft, and other vehicles. The only requirement is that the nonlinear thermal characteristics of such devices are described by an algebraic function (that is, functions that do not involve transcendentals). In practice, this requirement is fulfilled by approximating with polynomials of a sufficiently high degree.

Therefore, it is an object of the present invention to provide an apparatus for solving the steady-state temperature profile of a thermal environment.

It is another object of the present invention to provide a method for solving the steady-state temperature profile of a thermal environment.

It is another object of the present invention to provide a system for solving the steady-state temperature profile of a thermal environment, the system comprising the apparatus, the thermal environment, and a thermal data acquisition subsystem.

It is another object of the present invention to provide a computer program comprising instructions, once executed on a processor, for performing the steps of a method for solving the steady-state temperature profile of a thermal environment.

It is another object of the present invention to provide a non-transitory computer readable medium comprising instructions, once executed on a processor, for performing the steps of a method for solving the steady-state temperature profile of a thermal environment.

The invention provides methods and devices that implement various aspects, embodiments, and features of the invention, and are implemented by various means. The various means may comprise, for example, hardware, software, firmware, or a combination thereof, and these techniques may be implemented in any single one, or combination of, the various means.

For a hardware implementation, the various means may comprise processing units implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the various means may comprise modules (for example, procedures, functions, and so on) that perform the functions described herein. The software codes may be stored in a memory unit and executed by a processor. The memory unit may be implemented within the processor or external to the processor.

Various aspects, configurations, and embodiments of the invention are described. In particular, the invention provides methods, apparatus, systems, processors, program codes, computer readable media, and other apparatuses and elements that implement various aspects, configurations, and features of the invention, as described below.

### BRIEF DESCRIPTION OF THE DRAWING(S)

The features and advantages of the present invention will become more apparent from the detailed description set forth below when taken in conjunction with the drawings in which like reference characters identify corresponding elements in the different drawings. Corresponding elements may also be referenced using different characters.

FIG. 1 depicts a schematic thermal network model based on a single-node.

FIG. 2 depicts a schematic thermal network model based on a wire heated by an electrical current, in contact with ambient air and radiating heat.

FIG. 3 depicts a system for operating a thermal environment according to one embodiment of the invention.

FIG. 4 depicts a method for operating a thermal environment according to another embodiment of the invention.

FIG. 5 depicts the thermal management system of a spacecraft.

FIG. 6 depicts a representative hardware environment for practicing the systems and methods described.

FIG. 7 depicts an exemplary Photovoltaic Thermal Control System (PVTCS) having unknown temperatures at several nodes.

FIG. 8 depicts the PVTCS system of FIG. 7 showing temperatures determined according to an embodiment of the invention.

### DETAILED DESCRIPTION OF THE INVENTION

### Thermal Network Modeling

The inventors have developed a heat transfer model by defining a discrete set of isothermal elements or “nodes” connected by heat-carrying “links”, which together represent the physical thermal environment. In this way, instead of using the fully detailed heat transfer equation of continuous media (a partial differential equation that would require costly finite-element techniques to solve, which is highly impractical for describing a large heterogeneous thermal environment), a set of ordinary differential equations is solved instead.

Each thermal node represents an item that, to a sufficient degree of accuracy, can be considered to have the same temperature throughout. Each node is then able to interchange heat with its neighbors in the network via heat carriers. In addition to these internal network flows, each node may have its own “injection” of heat (positive or negative), which are external to the network. The number and location of these nodes are chosen based on accuracy requirements, convenience in working with complex shapes, and efficient use of engineering and computer time.

A heat flow equation is proposed in its general form as follows:

$${( mc )}_{i} \frac{{dT}_{i}}{dt} = {{( {P}_{S + A + E} + {P}_{l} + {P}_{H} ) -}^{⟷}}^{Term 1} {{{\sum }_{j = 1}^{N} {C}_{ij} ( {T}_{i} - {T}_{j} )}^{⟷}}^{Term 2} {{- {\sum }_{j = 1}^{N} {A}_{i} σ ( {T}_{i}^{4} - {T}_{j}^{4} )}^{⟷}}^{Term 3} , \qquad [ equation 1 ]$$

where:
i, j=node number
Tᵢ=temperature of node i, absolute (K)
t=time (s)
mc=thermal mass, that is, heat capacity (J/K)
P_{S}=absorbed sunlight (W)
P_{A}=absorbed earth albedo (W)
P_{E}=absorbed earth infrared radiation (W)
P_{I}=component power (W)
P_{H}=heater power (W)
Cᵢⱼ=thermal conductance (W/K)
Aᵢⱼ=surface area (m²)
Fᵢⱼ=“script-F” radiation coefficient
s=Stefan-Boltzmann constant (W/m²/K⁴).

The first “injection” terms P (Term 1) represent heat that gets injected into the node by whatever means, such as heat produced by devices inside the node, or heat absorbed by sunlight, etc. The transfer terms represent the mechanisms for heat transfer between network nodes: on the one hand, conductance/convection/advection (Term 2), which is linear in the temperature difference; on the other hand, radiation exchanges (Term 3), which grow as the fourth power of the temperature.

Some special nodes represent the “boundaries” of the system, and are considered heat baths having constant temperature. For instance, outer space would be a node with temperature T=0° K, and all elements on the exterior of the spacecraft would have a radiation-type link to this node. Since boundary nodes are assumed to have a constant known temperature, they do not contribute with equations to the system; only the “interior” nodes do. If one considers the steady state of the above thermal system, one obtains:

$${\sum }_{j = 1}^{N} {C}_{ij} ( {T}_{i} - {T}_{j} ) + {\sum }_{j = 1}^{N} {A}_{i} σ ( {T}_{i}^{4} - {T}_{j}^{4} ) = {Q}_{i} , \qquad [ equation 2 ]$$

where all node injections have been grouped into Qi. Hence, the steady state of thermal network systems is described by a set of algebraic equations, enabling its resolution via Thermal-HELM. Nevertheless, this resolution is not straightforward. As the inventors have realized, the resolution of the underlying algorithms follows a specific order in order to cater for the developed thermal model, which is described further on.

### T-Helm: Single-Node Thermal Network Model

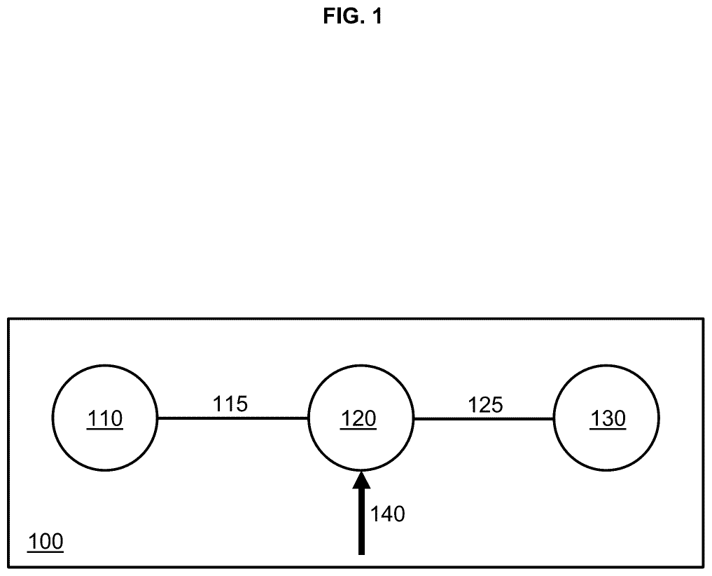

Thermal-HELM (extension of HELM to thermal network systems) will be analyzed in the simplest (but nontrivial) model: a system with just one interior node, transferring heat to one or more boundary nodes. Both conduction and radiation terms are considered, as in a realistic scenario. Schematically, this thermal network model is shown in FIG. 1. The steady-state equation for this model becomes:

$$hA ( T - {T}_{∞} ) + ε σ A ( {T}^{4} - {T}_{sur}^{4} ) = Q . \qquad [ equation 3 ]$$

The thermal environment 100 comprises a single interior node 120 with temperature T, having an internal heat injection Q 140. The node exchanges heat with two boundary nodes 110, 130. The first boundary node 110 is a heat bath at temperature T_{∞} and is assumed to exchange heat by convection 115. The second boundary node 130 exchanges heat by radiation 125, and it can be thought of as the “environment”, having a homogeneous temperature Tₛᵤᵣ (for instance, this could be a large enclosure). Here h 115 is the convection heat transfer coefficient, s 125 is a radiative property of the surface, the emissivity, and provides a measure of how efficiently a surface emits energy (per unit surface) relative to a blackbody, and s 125 is the Stefan-Boltzmann constant. The node transfers heat through a total area denoted by A 125.

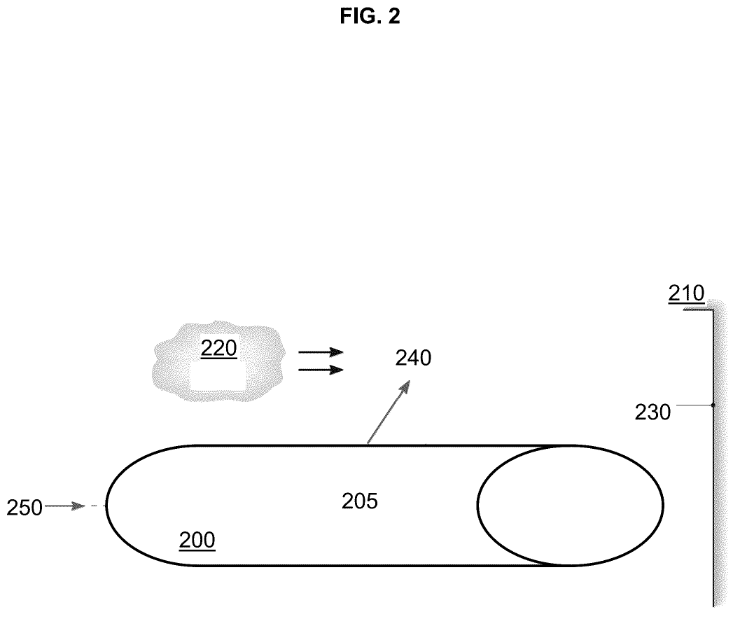

FIG. 2 depicts another exemplary representation; however, in the form of a copper wire 200 placed within an enclosure 210 (such as a cabinet or room) and surrounded by air 220, in order to make this abstract model a bit more concrete. The wire is heated by means of a constant electric current I 250. The wire transfers heat by convection 240 with the surrounding air, and by radiation 230 with the walls of the enclosing cabinet or room. The temperatures of both the surrounding air (T∞) and the enclosure (Tₛᵤᵣ) are assumed known and constant. In the steady state, that is, when the temperature T 205 of the wire is constant, the equation for this thermal network can be written as follows, for a piece of wire of unit length:

$$π hD ( T - {T}_{∞} ) + π ε σ D ( {T}^{4} - {T}_{sur}^{4} ) = {I}^{2} {R}_{e}^{′} \qquad [ equation 4 ]$$

where D is the diameter of the wire and R′ₑ is the wire resistance per unit length. This is an algebraic equation for the node temperature T. It is nonlinear but, as required by the method, the nonlinearity is algebraic in nature (in this case, a quartic polynomial).

### T-Helm: Solution in Closed Form

Defining the reduced temperature as t=T/T_{∞} in order to express the equation in dimensionless quantities, one obtains the polynomial equation in its most simple form:

$${τ}^{4} + a τ - b = 0 \qquad [ equation 5 ]$$

where the parameters a and b are given by:

$$a ≡ \frac{h}{εσ {T}_{∞}^{3}} \qquad [ equation 6 ]$$

$$b ≡ a + {τ}_{sur}^{4} + \frac{{I}^{2} {R}_{e}^{′}}{πεσ {DT}_{∞}^{4}} ,$$

Note that both coefficients a and b are positive, since they are defined in terms of constants that are all positive. This is important, as there is already some relevant information that can be extracted from this equation just using some elementary results from the mathematics of polynomial equations. In particular, Descartes' rule of signs tells us that if the terms of a polynomial with real coefficients are ordered by descending exponent, then the number of positive roots is either equal to the number of sign changes between consecutive nonzero coefficients, or is less than it by an even number (multiple roots are counted separately). In the case at hand, there is only one sign change (from a to b), and therefore the equation has only one real positive root. Performing the change of variables x=−τ, one can also conclude that the equation has only one negative real root. The other two roots are a pair of complex conjugate values.

The solutions to the quartic equation can be found in closed form. Using Descartes' solution method, the solutions to the following resolvent cubic equation are first determined:

$${y}^{3} + 4 by - {a}^{2} = 0. \qquad [ equation 7 ]$$

From these, the single real positive root provides the physical solution to the original problem:

$$τ ≡ \frac{T}{{T}_{∞}} = \frac{γ}{2} ( \sqrt{\frac{2 a}{{γ}^{3}} - 1} - 1 ) = γ \frac{\frac{a}{{γ}^{3}} - 1}{1 + \sqrt{\frac{2 a}{{γ}^{3}} - 1}} . \qquad [ equation 8 ]$$

This closed-form expression for the solution facilitates computations, as well as being useful for testing and validating numerical implementations of T-HELM. As mentioned above, the four solutions to this quartic always consist of one positive real, one negative real, and two complex-conjugate values. The only physical solution in this case is the one that is real and positive.

### T-Helm: S-Representation

In T-HELM, an embedding for the algebraic equation is devised, using a complex parameter s, in a way that the variables (in this case the temperature) become holomorphic functions of the embedding parameter. Actually, the variables become a plane algebraic curve parameterized in s. In order to be useful for calculation purposes, the embedding is designed in such a way that at some reference point (usually s=0) it is trivial to identify and obtain the particular solution of interest. The embedding is also required to make physical sense, meaning that the analytic continuation of such solution from s=0 to s=1 (the point at which one recovers the original equations) should reflect a physical situation all along the path. In other words, this continuation path should be free of any extraneous singularities introduced by the embedding itself.

In this case, the embedding was designed as follows. One seeks a reference state at s=0 in which all nodes of the network have the same reference temperature, and there are no injections and there is no heat transfer between the nodes (i.e., a uniformly thermalized network). Here one needs to select a boundary node as the reference node that will provide such reference temperature. The injections are embedded with a factor of s, in order to make them vanish at s=0. The rest of the boundary nodes, which have fixed temperatures in general different from the reference node, also need to be embedded adequately; for instance, using a linear ramp in s interpolating between the reference temperature at s=0 and the actual boundary node temperature at s=1. The technique of linear ramping has the advantage that it generates the least amount possible of extra singularities in the associated algebraic curve (such singularities may reduce the rate of convergence of the Padé Approximants in the analytic continuation stage, which is prevented by linear ramping in this case).

Taking all this into account, the proposed embedding becomes:

$$h ( T ( s ) - {T}_{∞} ) + εσ ( {T ( s )}^{4} - {T}_{∞}^{4} ) + εσ s ( {T}_{∞}^{4} - {T}_{sur}^{4} ) = s \frac{{I}^{2} {R}_{e}^{′}}{π D} \qquad [ equation 9 ]$$

where T_{∞} has been selected as the reference state temperature. At s=0, the system has no heat injections and all nodes are at temperature T_{∞}, and therefore there is no heat flow. At s=1, the original system is recovered. Moreover, all intermediate states along the path from s=0 to s=1 (using real values of s) make sense as a system that could be physically materialized.

The above equation can be rewritten in dimensionless variables using the reduced temperature c and the parameters a, b defined above. One arrives at this final expression, which is readily identified as an algebraic curve:

$${τ ( s )}^{4} + a τ ( s ) + s ( 1 + a - b ) - 1 - a = 0. \qquad [ equation 10 ]$$

At s=1, the polynomial expression seen above is recovered, while at s=0 one obtains the equation:

$${τ ( 0 )}^{4} + a τ ( 0 ) - 1 - a = 0 \qquad [ equation 11 ]$$

which, by Descartes' rule, has only one positive real root, which is clearly τ(0)=1 as expected.

### T-Helm: N-th Order Representation

The method now considers the power series representation of the selected solution at the reference point, that is, the germ of the relevant branch of the algebraic curve, which will eventually provide the solution of interest at s=1. The following notation will be adopted for the power series coefficients:

$$τ ( s ) = {\sum }_{N = 0}^{∞} τ [ N ] {s}^{N} . \qquad [ equation 12 ]$$

The selected germ is such that τ[0]=1, since for this branch one has τ(0)=1.

The inventors have realized an additional problem regarding how the fourth-power term in equation 10 should be addressed. The direct application of the standard HELM procedure entails the substitution of the power series (equation 12) into equation 10, however then the fourth-power term results in fourth-order self-convolutions of series coefficients, which are not only very cumbersome to calculate but also result in large numerical errors later on, which is computationally very intensive, making real-time processing extremely hard. Instead, the following auxiliary power series is used:

$${τ ( s )}^{4} = {\sum }_{N = 0}^{∞} {τ}^{( 4 )} [ N ] {s}^{N} . \qquad [ equation 13 ]$$

Here τ⁽⁴⁾[N] is a symbol to designate the power series coefficients of the function τ(s)⁴, which are definitely not the same as the fourth power of those of function τ(s). However, the power series coefficients of these two series are certainly related, since the function τ(s)⁴ is just function τ(s) raised to the fourth power. To make this relation explicit, we derive this functional relationship with respect to s, applying the chain rule:

$$τ ( s ) \frac{d ( {τ ( s )}^{4} )}{ds} = 4 {τ ( s )}^{4} \frac{d τ ( s )}{ds}$$

Substituting the power series for these two functions, one obtains:

$$( {\sum }_{N = 0}^{∞} τ [ N ] {s}^{N} ) ( {\sum }_{N = 0}^{∞} ( N + 1 ) {τ}^{( 4 )} [ N + 1 ] {s}^{N} ) = 4 ( {\sum }_{N = 0}^{∞} {τ}^{( 4 )} [ N ] {s}^{N} ) ( {\sum }_{N = 0}^{∞} ( N + 1 ) τ [ N + 1 ] {s}^{N} )$$

And, after some straightforward rearrangement:

$${\sum }_{k = 0}^{N} ( k + 1 ) τ [ N - k ] {τ}^{( 4 )} [ k + 1 ] = 4 {\sum }_{k = 0}^{N} ( k + 1 ) {τ}^{( 4 )} [ N - k ] τ [ k + 1 ]$$

Using these two power series, the embedded heat transfer equation is expressed as an “Nth order representation”, by equating power series coefficients of equal order. At order N+1, one obtains:

$${τ}^{( 4 )} [ N + 1 ] + a τ [ N + 1 ] + ( 1 + a - b ) {δ}_{N , 0} = 0 ( N = 0 , 1 , … ) . \qquad [ equation 14 ]$$

And finally, making use of the expression above relating the coefficients of τ(s) and those of τ(s)⁴, the final result is:

$$τ [ N + 1 ] = \frac{- 1}{( N + 1 ) ( a + 4 )} \text{} {\sum }_{k = 0}^{N - 1} ( k + 1 ) \text{} ( 4 {τ}^{( 4 )} [ N - k ] τ [ k + 1 ] - τ [ N - k ] \text{} {τ}^{( 4 )} [ k + 1 ] ) - \frac{1 + a - b}{a + 4} {δ}_{N , 0} ( N = 0 , 1 , … ) \qquad [ equation 15 ]$$

$$and$$

$${τ}^{( 4 )} [ N + 1 ] = 4 τ [ N + 1 ] + \frac{1}{N + 1} {\sum }_{k = 0}^{N - 1} ( k + 1 ) \text{} ( 4 {τ}^{( 4 )} [ N - k ] τ [ k + 1 ] - τ [ N - k ] {τ}^{( 4 )} [ k + 1 ] ) \text{} ( N = 0 , 1 , … ) . \qquad [ equation 16 ]$$

Therefore, the power series terms of both τ(s) and τ(s)⁴ at order N+1 are obtained in terms of the corresponding coefficients at order N and lower (first calculating τ[N+1] using equation 15, then τ⁽⁴⁾[N+1] using equation 16). This provides the mechanism to sequentially compute all power series terms of τ(s), up to the desired order. Critically, note that this sequence should be started with the coefficient τ[0]=1, which corresponds to the selected reference solution at s=0, namely t=1.

The rest of the method consists in carrying out the analytic continuation of the power series of τ(s) at point s=1, typically by means of Padé approximants (which, by Stahl's theorem, are guaranteed to converge in the maximal domain of single-valued analytic continuation of the given germ). Other approximants are possible, and are readily available to the skilled artisan; however, the inventors preferably utilize Padé approximants due to their inherent advantageous properties.

### T-Helm: Critical Points of the Algebraic Curve

It was shown that the single-node thermal network is solvable in closed form, since the equation is a quartic. Its holomorphically embedded counterpart also allows for solving the critical points s_{cr} of the algebraic curve (equation 10) in closed form. Again, this is quite important for purposes of verification and validation of numeric implementations of T-HELM. It is also useful for gaining insight into the analytic structure of the problem and how the solution branches behave. Straightforward calculation of the critical points s_{cr} of equation 10 shows that two of them are complex and one is real. The one of interest for this analysis is the real one, s_{cr}⁽⁰⁾:

$${s}_{cr}^{( 0 )} = - \frac{\frac{3 \sqrt[3]{2}}{8} {a}^{4 / 3} + a + 1}{b - a - 1}$$

In order to have a well-defined power series for the solution at s=0, it is desirable to avoid that s_{cr}⁽⁰⁾ lies right at zero. However, since a is defined positive, this cannot happen, as the numerator in this expression cannot vanish.

It is also desirable to avoid having the value s_{cr}⁽⁰⁾ lying on the path from s=0 to s=1, since this would contradict the assumption that the solution at s=1 is the analytic continuation of the calculated germ (along the path on the real axis). The numerator is always positive, but the expression in the denominator could in principle have any sign. From the definition above, recall that:

$$b - a - 1 = \text{?} + \frac{\text{?} {I}^{2}}{π D εσ \text{?}} - 1. \qquad [ equation 17 ]$$

$$\text{?} \text{indicates text missing or illegible when filed}$$

If this expression is positive (which happens when Tₛᵤᵣ>T_{∞}), then s_{cr}⁽⁰⁾ lies on the negative real axis, and the solution will not encounter any obstacle to the analytic continuation to s=1. If, on the other hand, Tₛᵤᵣ<T_{∞}, it is then straightforward to show that s_{cr}⁽⁰⁾>1. As a conclusion, it has been proven that the only real-valued singularity cannot lie on the segment [0, 1]. Therefore, in this single-node system the sought solution can always be obtained as the analytic continuation of the reference solution to the point s=1.

Regarding the location of the other two complex conjugate critical points, if they ever get too close to the point s=0, they could have an influence on the numerical stability of the method. The convergence radius R is determined by the closest singularity to the origin; therefore, in this case, R will always be given by the complex conjugated critical points:

$$R = \vert {s}_{cr}^{( \pm )} \vert = \frac{\sqrt{\frac{9 \sqrt[3]{4}}{64} {a}^{8 / 3} + {( a + 1 )}^{2} - ( a + 1 ) \frac{3 \sqrt[3]{2}}{8} {a}^{4 / 3}}}{\vert b - a - 1 \vert} . \qquad [ equation 18 ]$$

The value of the numerator starts at 1 for a=0 and then grows monotonically with a. Therefore, the only way in which R could become very small is if the parameter b in the denominator grows very large. This case, b→∞ while a<∞, could correspond to either Tₛᵤᵣ→∞ or I→c, for instance. In order to prevent such undesirable scenario, in an aspect of the invention, the Padé-Weierstrass technique is applied in order to increase the numerical precision of the T-HELM calculations. This is optional, as it does not need to be applied all the time, but rather in those specific cases wherein the singularities happen to be located too close to the origin. In such scenarios, a more focused computation results in more accurate estimations.

In conclusion, the analysis of the algebraic curve corresponding to this model shows that there are only three critical points. Two of them are a pair of complex conjugate values, and the third one is real. Depending on the value of the parameters a, b (which are always positive), this real-valued singularity may be positive or negative; but it is proven that when it is positive, its value is always greater than one. The conclusion is that the path on the real axis of complex plane, from s=0 to s=1, is free of singularities. This proves that T-HELM's reference solution at s=0 has an analytic continuation all along that path, and therefore it guarantees that this analytic continuation will be the sought solution. In terms of numerical stability of the method, one should also analyze whether or not the singularities could get too close to the point s=0, since this would yield a power series with a small convergence radius and it could potentially have an impact on the numerical precision of the Padé approximants. However, the analysis also shows that the only ways in which this could happen belong to asymptotic cases: either Tₛᵤᵣ→∞ or I→∞. Even in such cases, numerical stability can be regained by means of the Padé-Weierstrass technique for analytic continuation, which has also been adapted to thermal models.

### T-Helm: General N-Node Thermal Network Model

The treatment developed for the single-node model shown in the previous section is herein extended to a general network consisting on n thermal nodes. The expressions are now provided in summarized form, without the detailed derivation of the previous sections.

Equations in the s-Representation

One of the boundary nodes is chosen as the reference, Tref. The equations to be solved, in dimensionless variables, are:

$${\sum }_{j = 1}^{n} {ℂ}_{ij} {τ}_{j} + {\sum }_{j = 1}^{n} {ℝ}_{ij} {τ}_{j}^{4} = {J}_{i} : {τ}_{i} ≡ \frac{{T}_{i}}{{T}_{ref}} : {J}_{i} ≡ \frac{{Q}_{i}}{{T}_{ref}} \qquad [ equation 19 ]$$

where the matrices representing the thermal conduction/convection and thermal radiation links are defined respectively as:

$${ℂ}_{ij} ≡ {δ}_{ij} \text{?} - \text{?} : {ℝ}_{ij} ≡ {T}_{ref}^{3} ( {δ}_{ij} \text{?} - \text{?} ) . \qquad [ equation 20 ]$$

$$\text{?} \text{indicates text missing or illegible when filed}$$

The heat injections Jᵢ are embedded by a multiplicative factor in s. Any extra boundary nodes having a temperature different from Tref are embedded as in the previous section, that is, using a linear ramp: (1−s)Tref+s Tk.

The general form of the embedded equations becomes:

$${\sum }_{j = 1}^{N} {ℂ}_{ij} {τ}_{j} ( s ) = {sJ}_{i} - {\sum }_{j = 1}^{N} {ℝ}_{ij} {τ}_{j}^{( 4 )} ( s ) . \qquad [ equation 21 ]$$

As can be seen, the embedded heat flow equation comprises a radiation term as a function of the fourth power of temperature.

This embedded equation achieves the sought goal. At s=0 the system represents a network with no heat injections, for which there is an unambiguous reference steady-state solution, namely the thermalized network: all nodes are at the same temperature T_{ref} and there is no heat flow between them. At s=1 the system represents the original network that we are trying to solve. The embedding, since it is holomorphic, allows one to obtain the solution at s=1 as the analytic continuation of the reference solution at s=0. Now the next step is to calculate this reference solution, in the form of its power series representation (the so-called “germ”). Once this is calculated, the rest of the process consists in performing the analytical continuation by means of Padé Approximants. As mentioned above in the example of the one-node system, it is advantageous aspect to address the terms involving the fourth power of temperatures by means of the corresponding auxiliary power series that represent the function “temperature to the fourth power”, and the formulas that relate the power series terms of temperature and said fourth-power function.

### Equations in the N-th Order Representation

The required formulas are as follows:

$${\sum }_{j = 1}^{N} ( {≫}_{ij} + 4 {≫}_{ij} + ( {G}_{i} - {R}_{i} ) {δ}_{ij} ) {τ}_{j} [ N + 1 ] = {T}_{i} ( N ) - {\sum }_{j = 1}^{N} {≫}_{ij} {T}_{j}^{( 4 )} ( N ) \qquad [ equation 22 ]$$

$${τ}_{i}^{( 4 )} [ N + 1 ] = 4 {τ}_{i} [ N + 1 ] + \frac{1}{N + 1} {\sum }_{k = 0}^{N - 1} ( k + 1 ) ( 4 {τ}_{i}^{( 4 )} [ N - k ] {τ}_{i} [ k + 1 ] - {τ}_{i} [ N - k ] {τ}_{i}^{( 4 )} [ k + 1 ] ) . \qquad [ equation 23 ]$$

In the same vein as the one-node example seen before, and starting with coefficients at order zero tⱼ[0]=1, one sequentially calculates the coefficients at order N+1 from those already calculated at order N and earlier. At each order, one first solves equation 22 to obtain coefficients tⱼ[N+1] and then one solves equation 23 to obtain tⱼ⁽⁴⁾[N+11]. The rest of the procedure, as before, consists in performing the analytic continuation of each power series (each temperature function) at s=1 by means of Padé approximants.

### T-Helm: Implementation

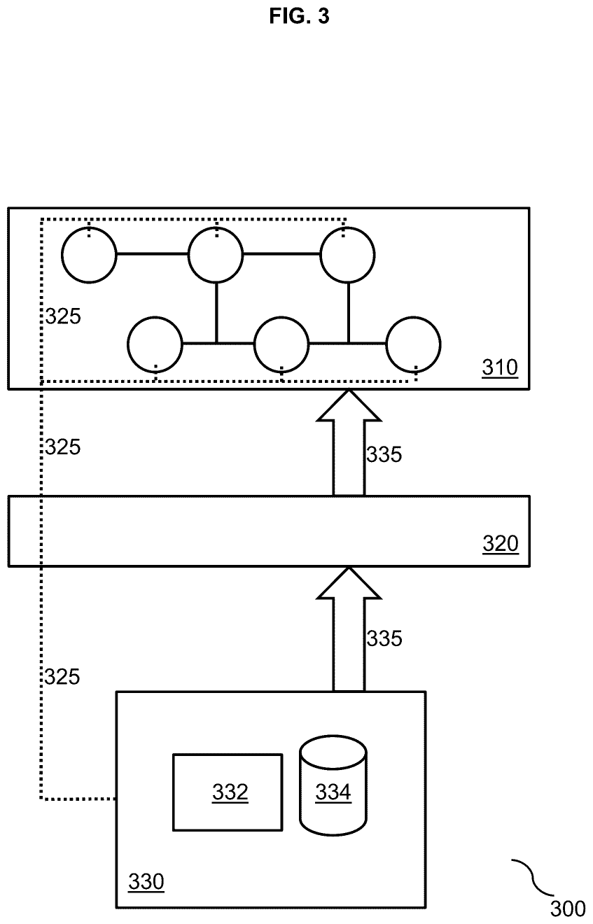

FIG. 3 depicts a system for operating a thermal environment according to one embodiment of the invention. The system 300 comprises the thermal environment 310 under operation and management, a supervisory control and data acquisition subsystem 320 configured for collecting thermal data from the thermal environment, and a microprocessor-controlled heat control apparatus 330 for solving the steady-state temperature profile of the thermal environment. The supervisory control and data acquisition system is, on one hand, in data communications with the thermal environment, and on the other hand, in data communications with the microprocessor-controlled heat control apparatus. As mentioned, the thermal environment comprises thermal nodes (shown as circles) having known and unknown temperatures, and one of the objectives is to determine the unknown temperatures. The nodes comprise at least one of heat sources and/or heat sinks and/or heat carriers, such as walls, containers, supports, rooms and/or housing.

To this effect, the supervisory control and data acquisition subsystem is configured to collect thermal data from all the nodes of the thermal environment (dotted lines 325) and transmit this information to the microprocessor-controlled heat control apparatus (dotted lines 325). Once the microprocessor-controlled heat control apparatus determines all unknown temperatures, and completes the thermal environment's steady-state temperature optimization process, it transmits (control line 335) respective control signals to corresponding heat sources and sinks of the thermal environment, to effect the instructed temperature changes. This is implemented by first communicating with the supervisory control and data acquisition subsystem, which forwards the instructions (control line 335) to the corresponding nodes of the thermal environment.

The microprocessor-controlled heat control apparatus 330 comprises at least one processor 332 and at least one memory 334. Processor 332 can be implemented in a variety of manners readily available to the skilled artisan, such as a general-purpose processor, a digital signal processor (DSP), and application specific integrated circuit (ASIC), a field programmable gate array (FPGA), or other programmable logic device, discrete gate or transistor logic, discrete hardware components, or any combination thereof designed to perform the functions described. A general-purpose processor may be a microprocessor, but in the alternative, the processor may be any conventional processor, controller, microcontroller, or state machine.

The memory 334, or non-transitory computer readable medium, may be any medium holding programming language to execute the described method steps, such as software modules residing in RAM memory, flash memory, ROM memory, EPROM memory, EEPROM memory, registers, hard disk, a removable disk, a CD-ROM, or any other form of storage medium known in the art. Memory also comprises non-transitory computer-readable media including, but not limited to, magnetic storage devices (for example, hard disk, floppy disk, magnetic strips, etc.), optical disks (for example, compact disk (CD), digital versatile disk (DVD), etc.), smart cards, and flash memory devices (for example, EPROM, card, stick, key drive, etc.). Additionally, various storage media described herein can represent one or more devices and/or other machine-readable media for storing information. The term machine-readable medium can include, without being limited to, various media capable of storing, containing, and/or carrying instruction(s) and/or data. Additionally, a computer program product may include a computer readable medium having one or more instructions or codes operable to cause a computer to perform the functions described herein.

Furthermore, it is to be understood that the embodiments, realizations, and aspects described herein may be implemented by various means in hardware, software, firmware, middleware, microcode, or any combination thereof. Various aspects or features described herein may be implemented, on one hand, as a method or process or function, and on the other hand as an apparatus, a device, a system, or computer program accessible from any computer-readable device, carrier, or media. The methods or algorithms described may be embodied directly in hardware, in a software module executed by a processor, or a combination of the two.

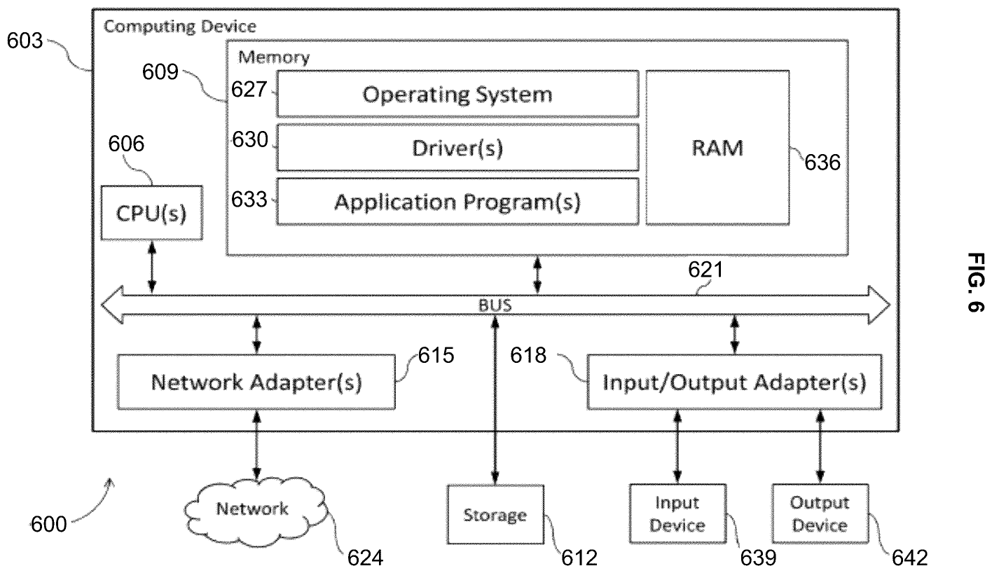

FIG. 6 depicts, in further detail, a representative hardware environment for practicing the systems and methods described herein. This schematic drawing illustrates a hardware configuration of an information handling/computing system 600 in accordance with systems and methods herein. The computing system 600 comprises a computing device 603 having at least one processor or central processing unit (CPU) 606, internal memory 609, storage 612, one or more network adapters 615, and one or more input/output adapters 618. A system bus 621 connects the CPU 606 to various devices such as the internal memory 609, which may comprise random access memory (RAM) and/or read-only memory (ROM), the storage 612, which may comprise magnetic disk drives, optical disk drives, a tape drive, etc., the one or more network adapters 615, and the one or more input/output adapters 618. Various structures and/or buffers (not shown) may reside in the internal memory 609 or may be located in a storage unit separate from the internal memory 609.

The one or more network adapters 615 may include a network interface card such as a LAN card, a modem, or the like to connect the system bus 621 to a network 624, such as the Internet. The network 624 may comprise a data processing network. The one or more network adapters 615 perform communication processing via the network 624.

The internal memory 609 stores an appropriate Operating System 627, and may include one or more drivers 630 (for example, storage drivers, or network drivers). The internal memory 609 may also store one or more application programs 633 and include a section of Random Access Memory (RAM) 636. The Operating System 627 controls transmitting and retrieving packets from remote computing devices (for example, host computers, storage systems, Supervisory Control and Data Acquisition systems-SCADA, etc.) over the network 624. In some systems and methods, the SCADA and/or Energy Management Systems (EMS) may connect to the computing system 600 over the network 624. The drivers 630 execute in the internal memory 609 and may include specific commands for the network adapter 615 to communicate over the network 624. Each network adapter 615 or driver 630 may implement logic to process packets, such as a transport protocol layer to process the content of messages included in the packets that are wrapped in a transport layer, such as Transmission Control Protocol (TCP) and/or Internet Protocol (IP).

The storage 612 may comprise an internal storage device or an attached or network accessible storage. Storage 612 may include disk units and tape drives, or other program storage devices that are readable by the system. A removable medium, such as a magnetic disk, an optical disk, a magneto-optical disk, a semiconductor memory, or the like, may be installed on the storage 612, as necessary, so that a computer program read therefrom may be installed into the internal memory 609, as necessary. Programs in the storage 612 may be loaded into the internal memory 609 and executed by the CPU 606. The Operating System 627 can read the instructions on the program storage devices and follow these instructions to execute the methodology herein.

The input/output adapter 618 can connect to peripheral devices, such as input device 639 to provide user input to the CPU 606. The input device 639 may include a keyboard, mouse, pen-stylus, microphone, touch sensitive display screen, or any other suitable user interface mechanism to gather user input. An output device 642 can also be connected to the input/output adapter 618, and is capable of rendering information transferred from the CPU 606, or other component. The output device 642 may include a display monitor (such as a Cathode Ray Tube (CRT), a Liquid Crystal Display (LCD), or the like), printer, speaker, etc.

The computing system 600 may comprise any suitable computing device 603, such as a mainframe, server, personal computer, workstation, laptop, handheld computer, telephony device, network appliance, virtualization device, storage controller, etc. Any suitable CPU 606 and Operating System 627 may be used. Application Programs 633 and data in the internal memory 609 may be swapped into storage 612 as part of memory management operations.

It is expected that any person skilled in the art can implement the disclosed procedure using a computer program. The computer program may include instructions that would be provided to a processor of a general purpose computer, special purpose computer, or other programmable data processing apparatus to produce a machine, such that the instructions that execute via the processor of the computer or other programmable data processing apparatus obtain the steady-state thermal profile for a given thermal network model under various realizations of positive or negative heat injection, and other parameters. The generalization of the example charts shown above to any other thermal network model should be evident to any person skilled in the art.

As will be appreciated by one skilled in the art, aspects of the systems and methods herein may be embodied as a system, method, or computer program product. Accordingly, aspects of the present disclosure may take the form of an entirely hardware system, an entirely software system (including firmware, resident software, micro-code, etc.) or a system combining software and hardware aspects that may all generally be referred to herein as a “circuit,” “module”, or “system.” Furthermore, aspects of the present disclosure may take the form of a computer program product embodied in one or more computer readable medium(s) having computer readable program code embodied thereon.

Any combination of one or more computer readable or processor readable, non-transitory medium may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a Read-Only Memory (ROM), an Erasable Programmable Read-Only Memory (EPROM or Flash memory), an optical fiber, a magnetic storage device, a portable compact disc Read-Only Memory (CD-ROM), an optical storage device, a “plug-and-play” memory device, like a USB flash drive, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

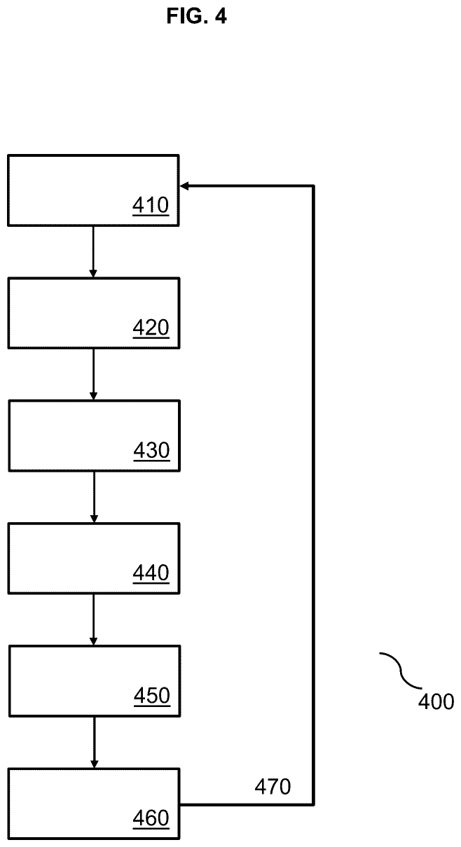

FIG. 4 depicts a method for operating a thermal environment according to another embodiment of the invention. The method steps are executed by the microprocessor-controlled heat control apparatus described.

Initially, the apparatus receives 410 thermal data corresponding to different points of the thermal environment and forms 420 heat flow equations from the received thermal data. The thermal data comprises known temperatures and heat flows from and between the components of the thermal environment, as well as known equipment parameters. The heat flow equations model the thermal environment, and since the thermal environment comprises non-linear elements, the heat flow equations approximate the nonlinearity of these elements by algebraic functions.

In one aspect, the heat flow equations comprise a term representing generated heat. In another aspect, the heat flow equations comprise a term representing heat propagation via convection. In another aspect, the heat flow equations comprise a term representing radiation. In another aspect, the heat flow equations comprise a term representing extracted heat. In yet another aspect, the heat flow equations comprise any combination of these terms. The thermal data is received from a supervisory and data acquisition system.

The method continues to develop 430, in power series, temperatures for an embedded heat flow equation about s=0, the embedded heat flow equation resulting from the embedding of a heat flow equation in a holomorphic embedding using a complex embedding parameter s, where s is a variable in a complex domain that includes a value s=0 that represents a thermal environment with the same temperature throughout, and includes a value s=1 that represents the thermal environment with all nodes connected, wherein each variable of the embedded heat flow equation is contained as a function of the variable s by said holomorphic embedding. This design of a proper embedding advantageously results in a solution of the embedded heat flow equation which comprises only a single real-valued positive singularity greater than one representing the reference solution at s=0 having a path analytic continuation all along the path.

In one aspect, the embedded heat flow equation comprises embedding boundary nodes with a linear ramp in s interpolating between a reference temperature at s=0 and an actual temperature at s=1. In another aspect, the source and boundary nodes are embedded by a multiplicative complex parameter s. In another aspect, the embedded heat flow equation comprises a radiation term as a function of the fourth power of temperature. In another aspect, the radiation term is further a holomorphic function of the complex parameter s.

Next, the germ of the reference solution is calculated. In one aspect, the power series developing comprises computing an n-order algebraic approximant to the power series and evaluating the n-order algebraic approximant for said power series. In another aspect, the power series developing comprises computing algebraic approximants to determine a sum of all the coefficients of the power series expansion for the heat flow equations representative of current, physical heat flow that is to be determined. Successive terms of the power series are progressively computed to a desired accuracy.

Next, the analytic continuation to s=1 is performed. In one aspect, the thermal data is substituted 440 into said embedded heat flow equation and a recurrence relationship results that obtains coefficients of said power series at order N+1 from the coefficients at order N and preceding orders. Next, successive terms of the power series are progressively computed 450 and finally the unknown temperatures are determined 460 using the successive terms of the power series by calculating the analytical continuation of the power series at s=1. This algorithm is then repeated iteratively 470 to provide a continuous updating of temperatures of the thermal environment. This iterative repetition is continued until a desired accuracy is met.

Once the temperatures are determined, they can be used for managing the thermal environment. This comprises operating, visualizing, designing, managing, modifying, or optimizing the thermal environment. In one aspect, the temperatures of the nodes of the thermal environment are established for steady state operation of said thermal environment. In another aspect, a continuous, real-time measure of the heat flow in the thermal environment is provided. In another aspect, the temperatures and heat flow at and between the nodes are continuously updated. In yet another aspect, the updated temperatures and heat flows are displayed.

The block diagrams in FIGS. 3 and 6 and the flowchart in FIG. 4 illustrate the architecture, functionality, and operation of possible implementations of systems, methods, and computer program products according to various systems and methods herein. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in FIG. 4. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### T-Helm: Applications

In one application case, the thermal environment is an airplane or spacecraft having a thermal management system, comprising heat sources (such as electric motors or jet engines), heat sinks (such as an active and passive cooling systems), and heat carriers (such as the enclosure). In this case, the determination of the steady-state thermal profile is crucial for enabling algorithmic control. Such control strategies work by performing intelligent exploration of the space of feasible steady states of the system and selecting optimal paths of control actions. Therefore, it is of utmost importance that all explored steady states are calculated reliably. Iterative methods cannot ensure such reliability, as they sometimes fail to converge for no controllable reason.

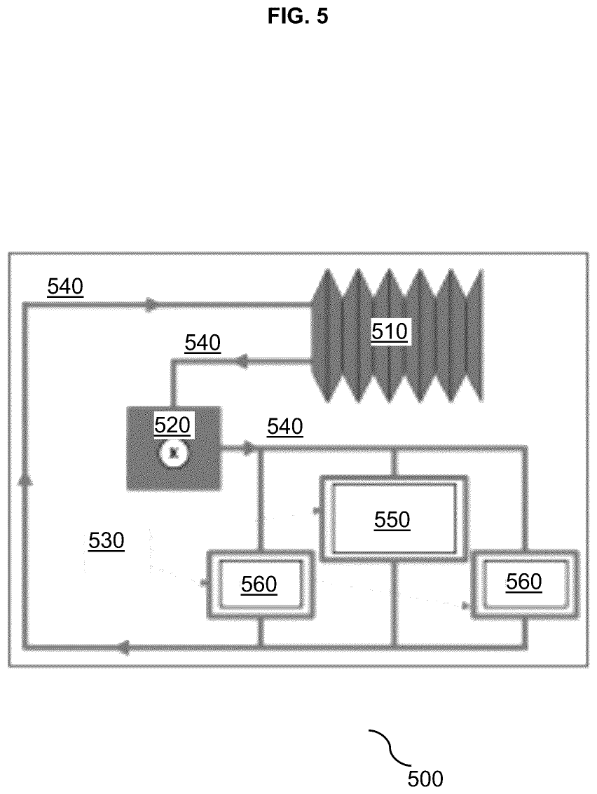

A typical spacecraft has four solar power array wings. FIG. 5 depicts a Photovoltaic Thermal Control System PVTCS 500 managing the thermal profile of each of four solar power array wings. The PVTCS is a single-phase pumped ammonia loop. The system incorporates two pumps and dual heat rejection loops in the deployable radiator for operational redundancy. For all the important elements of the PVTCS system, effective steady-state equivalent models have been developed. The paragraphs below provide a short description of the main elements used in the PVTCS system.

The pump 520 provides the circulation, loop pressurization, and temperature control of the ammonia loop. The pump mixes cool ammonia exiting the radiators with warm ammonia coming from the heat acquisition subsystem. The Photovoltaic Radiator 510, which is a critical component of the active system, consists of seven panels (each about 6 by 12 feet) designed to deploy in orbit from a 2-foot-high stowed position to a 50-foot-long extended position. Radiators are typically sized to reject heat during the worst-case combination of peak heat load and least favorable environment.

The thermal cold plates 530 are made of metals such as aluminum and stainless steel, including heat transfer fins, which are required to enhance the unit's heat exchanger efficiency. Higher efficiency/lower mass designs can be realized through the use of micro-channel fabrication techniques or the use of composite materials. They are used in the process of acquiring excess thermal energy from different types of components (heat acquisition process).

The heat pipes 540 (coolant loops) are the most common capillary-driven devices used in spacecraft today. A traditional heat pipe includes a hollow tube, sealed on both ends, with an interior wick and a circulating fluid. The fluid is generally contained within a tube, or separate tubes for the liquid and vapor sides, and is continuously recycled. The fluid can be circulated either by a mechanical pump or by the capillary forces generated by a wick. Heat pipes can transport up to hundreds of watts for several meters, at negligible temperature drop, along the length of the pipe. Heat pipes are a well-developed technology today.

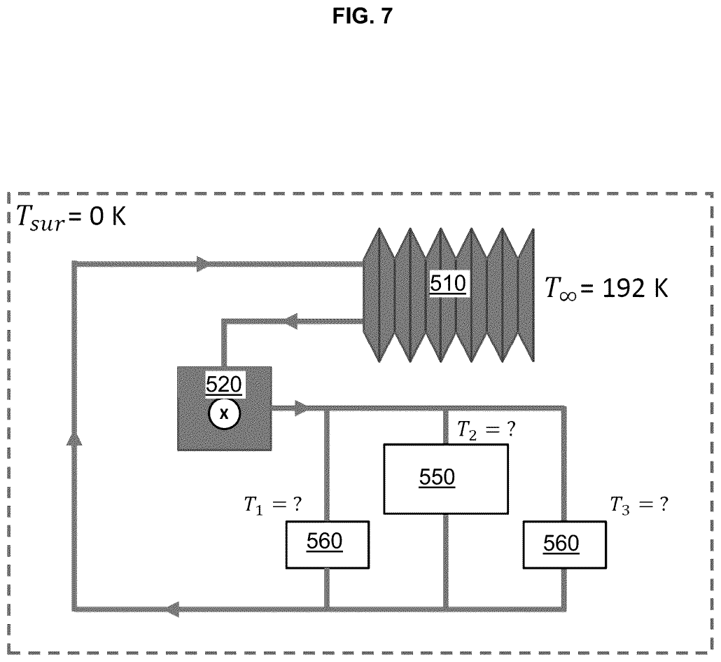

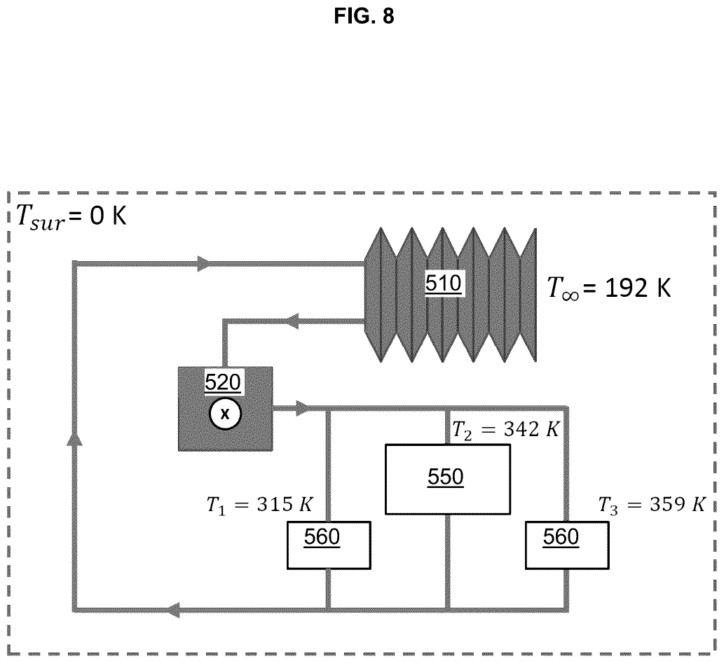

The thermal system model developed defines a pumped liquid cooling system model including all the previous components for steady state analysis using the Thermal-HELM methodology. The model consists of a pump 520, the heat exchange at cold plates 530, the radiator 510, and the liquid coolant lines 540. The pump circulates the fluid in the loop. The fluid picks up the heat at the cold plates by convection and dissipates it at the radiator by radiation into outer space. The acquisition loop collects heat from the electric system components via cold plates associated with them. One cold plate is attached to the BCDU component 550 (battery), while others are attached to the two DDCU units 560 (DC-DC converters). FIG. 7 depicts an example PVTCS wherein the temperatures T₁, T₂, and T₃, at nodes 550 and 560 are unknown. The execution of the innovative algorithm permits determining the steady-state temperatures of these nodes, as can be seen in FIG. 8.

In another application case, the thermal environment is a building, such as a house, an office building, an industrial building, a factory, or any similar enclosure. In this case, the determination of the steady-state thermal profile is important for the same reasons: it is the enabler of algorithmic control, and thus it can enable new forms of autonomous thermal management for buildings and compounds.

In another application case, the thermal environment is an electronic device or an integrated circuit. Heat is generated by electronic components, heat is sunk by the cooling system, and the motherboard acts as a heat carrier. In this case, the determination of the steady-state thermal profile is important for similar reasons: it enables algorithmic control, and this in turns enables an automatic thermal management that can dynamically manage the changing states of the chip or circuit.

Therefore, the different aspects of the invention described comprise an innovative algorithm for determining the steady-state temperatures of nodes in a thermal environment comprising non-linearities, however this determination is performed directly, that is non-iteratively, and guarantees the optimum solution is found, or indicates unfeasibility.

What has been described above includes examples of one or more embodiments. It is, of course, not possible to describe every conceivable combination, or permutation, of components and/or methodologies for purposes of describing the aforementioned embodiments. However, one of ordinary skill in the art will recognize that many further combinations and permutations of various embodiments are possible within the general inventive concept derivable from a direct and objective reading of the present disclosure. Accordingly, it is intended to embrace all such alterations, modifications, and variations that fall within scope of the appended claims.

1. An apparatus for solving the steady-state temperature profile of a thermal environment comprising thermal nodes having known and unknown temperatures, the apparatus comprising at least one memory and at least one processor configured for:
receiving thermal data corresponding to different points of the thermal environment;
forming heat flow equations from the received thermal data;
developing temperatures for an embedded heat flow equation wherein
the embedded heat flow equation results from the embedding of the heat flow equations in a holomorphic embedding using a complex embedding parameter s, where s is a variable in a complex domain that includes a value s=0 that represents a thermal environment with the same temperature throughout, and includes a value s=1 that represents the thermal environment with all thermal nodes connected, wherein each variable of the embedded heat flow equation is contained as a function of the variable s by said holomorphic embedding, said temperatures being developed in power series about s=0;
substituting said thermal data into said embedded heat flow equation and obtaining a recurrence relationship that obtains coefficients of said power series at order N+1 from the coefficients at order N and preceding orders;
progressively computing successive terms of the power series; and
determining the unknown temperatures using the successive terms of the power series by calculating the analytical continuation of the power series at s=1.

2. The apparatus of claim 1, wherein the thermal nodes comprise at least one of heat sources, heat sinks, and heat carriers.

3. The apparatus of claim 1, wherein the thermal data comprises known temperatures and heat flows from and between the components of the thermal environment, and known equipment parameters.

4. The apparatus of claim 3, further configured for receiving the thermal data from a supervisory and data acquisition system.

5. The apparatus of claim 3, wherein the heat flow equations model the thermal environment, and
wherein the thermal environment comprises non-linear elements, and the heat flow equations approximate the nonlinearity of the non-linear elements by algebraic functions.

6. The apparatus of claim 5, wherein the heat flow equations comprise a term representing at least one of:
generated heat,
heat propagation via convection,
radiation, and
extracted heat.

7. The apparatus of claim 3, further comprising computing algebraic approximants to determine a sum of all the coefficients of the power series expansion for the heat flow equations representative of current, physical heat flow.

8. The apparatus of claim 3, wherein the embedded heat flow equation further comprises boundary nodes embedded with a linear ramp in s interpolating between a reference temperature at s=0 and an actual temperature at s=1.

9. The apparatus of claim 8, wherein source and boundary nodes are embedded by a multiplicative complex parameter s.

10. The apparatus of claim 8, wherein a solution of the embedded heat flow equation comprises only a single real-valued positive singularity greater than one representing the reference solution at s=0 having a path analytic continuation all along the path.

11. The apparatus of claim 8, wherein the embedded heat flow equation further comprises a radiation term as a function of the fourth power of temperature.

12. The apparatus of claim 11, wherein the radiation term is a holomorphic function of the complex parameter s.

13. The apparatus of claim 3, further configured for progressively computing successive terms of the power series to a desired accuracy.

14. The apparatus of claim 13, further configured for progressively computing successive terms of the power series using Padé approximants.

15. The apparatus of claim 3, further configured for determining temperatures for steady state operation of said thermal environment and using said determined temperatures for managing the thermal environment comprising at least one of operating, visualizing, designing, managing, modifying, and optimizing the thermal environment.

16. The apparatus of claim 15, further configured for providing a continuous, real-time measure of the heat flow in the thermal environment and updating the temperatures and heat flow at and between the components of the thermal environment.

17. The apparatus of claim 16, further comprising displaying the updated temperatures and heat flows.

18. A computer implemented method for solving the steady-state temperature profile of a thermal environment comprising thermal nodes having known and unknown temperatures, the method comprising:
receiving thermal data corresponding to different points of the thermal environment;
forming heat flow equations from the received thermal data;
developing temperatures for an embedded heat flow equation wherein
the embedded heat flow equation results from the embedding of the heat flow equations in a holomorphic embedding using a complex embedding parameter s, where s is a variable in a complex domain that includes a value s=0 that represents a thermal environment with the same temperature throughout, and includes a value s=1 that represents the thermal environment with all thermal nodes connected, wherein each variable of the embedded heat flow equation is contained as a function of the variable s by said holomorphic embedding, said temperatures being developed in power series about s=0;
substituting said thermal data into said embedded heat flow equations and obtaining a recurrence relationship that obtains coefficients of said power series at order N+1 from the coefficients at order N and preceding orders;
progressively computing successive terms of the power series; and
determining the unknown temperatures using the successive terms of the power series by calculating the analytical continuation of the power series at s=1.

19. The method of claim 18, wherein the thermal nodes comprise at least one of heat sources, heat sinks, and heat carriers.

20. The method of claim 18, wherein the thermal data comprises known temperatures and heat flows from and between the components of the thermal environment, and known equipment parameters.

21. The method of claim 20, further comprising receiving the thermal data from a supervisory and data acquisition system.

22. The method of claim 20, wherein the heat flow equations model the thermal environment, and
wherein the thermal environment comprises non-linear elements, and the heat flow equations approximate the nonlinearity of these elements by algebraic functions.

23. The method of claim 22, wherein the heat flow equations comprise a term representing at least one of:
generated heat,
heat propagation via convection,
radiation, and
extracted heat.

24. The method of claim 20, further comprising computing algebraic approximants to determine a sum of all the coefficients of the power series expansion for the heat flow equations representative of current, physical heat flow.

25. The method of claim 20, wherein the embedded heat flow equation further comprises boundary nodes embedded with a linear ramp in s interpolating between a reference temperature at s=0 and an actual temperature at s=1.

26. The method of claim 25, wherein source and boundary nodes are embedded by a multiplicative complex parameter s.

27. The method of claim 25, wherein a solution of the embedded heat flow equation comprises only a single real-valued positive singularity greater than one representing the reference solution at s=0 having a path analytic continuation all along the path.

28. The method of claim 25, wherein the embedded heat flow equation further comprises a radiation term as a function of the fourth power of temperature.

29. The method of claim 28, wherein the radiation term is a holomorphic function of the complex parameter s.

30. The method of claim 25, further comprising progressively computing successive terms of the power series to a desired accuracy

31. The method of claim 30, further comprising progressively computing successive terms of the power series using Padé approximants.

32. The method of claim 20, further comprising determining temperatures for steady state operation of said thermal environment and using said determined temperatures for managing the thermal environment comprising at least one of operating, visualizing, designing, managing, modifying, and optimizing the thermal environment

33. The method of claim 32, further comprising providing a continuous, real-time measure of the heat flow in the thermal environment and updating the temperatures and heat flow at and between the elements.

34. The method of claim 33, further comprising displaying the updated temperatures and heat flows.

35. A non-transitory computer readable medium comprising instructions, once executed on a processor, for performing the method steps of a computer implemented method for solving the steady-state temperature profile of a thermal environment comprising thermal nodes having known and unknown temperatures, the computer implemented method comprising:
receiving thermal data corresponding to different points of the thermal environment;
forming heat flow equations from the received thermal data;
developing temperatures for an embedded heat flow equation wherein
the embedded heat flow equation results from the embedding of the heat flow equations in a holomorphic embedding using a complex embedding parameter s, where s is a variable in a complex domain that includes a value s=0 that represents a thermal environment with the same temperature throughout, and includes a value s=1 that represents the thermal environment with all thermal nodes connected, wherein each variable of the embedded heat flow equation is contained as a function of the variable s by said holomorphic embedding, said temperatures being developed in power series about s=0;
substituting said thermal data into said embedded heat flow equations and obtaining a recurrence relationship that obtains coefficients of said power series at order N+1 from the coefficients at order N and preceding orders;
progressively computing successive terms of the power series; and
determining the unknown temperatures using the successive terms of the power series by calculating the analytical continuation of the power series at s=1.

36. A computer program comprising instructions, once executed on a processor, for performing the method steps of a computer implemented method for solving the steady-state temperature profile of a thermal environment comprising thermal nodes having known and unknown temperatures, the computer implemented method comprising:
receiving thermal data corresponding to different points of the thermal environment;
forming heat flow equations from the received thermal data;
developing temperatures for an embedded heat flow equation wherein
the embedded heat flow equation results from the embedding of the heat flow equations in a holomorphic embedding using a complex embedding parameter s, where s is a variable in a complex domain that includes a value s=0 that represents a thermal environment with the same temperature throughout, and includes a value s=1 that represents the thermal environment with all thermal nodes connected, wherein each variable of the embedded heat flow equation is contained as a function of the variable s by said holomorphic embedding, said temperatures being developed in power series about s=0;
substituting said thermal data into said embedded heat flow equations and obtaining a recurrence relationship that obtains coefficients of said power series at order N+1 from the coefficients at order N and preceding orders;
progressively computing successive terms of the power series; and
determining the unknown temperatures using the successive terms of the power series by calculating the analytical continuation of the power series at s=1.
